(19) United States
(12) Patent Application Publication
(10) Pub. No.: US 2005/0162361 A1
(43) Pub. Date: Jul. 28, 2005

(54) Frame-shifted dynamic gamma correction method and system

(76) Inventors: Chao-Hsuan Chuang, Jhubei City (TW); Yiu-I Lin, Shulin City (TW); Nien-Hui Kung, Toufen Township (TW); Der-Jiunn Wang, Hsinchu (TW); Jing-Meng Liu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/040,024

(22) Filed: Jan. 24, 2005

(30) Foreign Application Priority Data
Jan. 27, 2004 (TW) 093101780

(51) Int. Cl. G09G 3/36

(52) U.S. Cl. 345/89

(57) ABSTRACT

A frame-shifted technique is disclosed for a dynamic gamma correction method and system that comprises counting the gray levels of each frame to figure out the probability distribution of gray levels in the current frame, and determining the gamma reference voltages according to the probability distribution of gray levels of the current frame for the gamma correction of the next frame.

### FIELD OF THE INVENTION

The present invention is related generally to a gamma correction method and system for a liquid crystal display (LCD), and more particularly, to a frame-shifted dynamic gamma correction method and system for an LCD.

### BACKGROUND OF THE INVENTION

Dynamic gamma correction is an image processing technology that improves the gray levels of display systems. Specifically, in a TFT-LCD display, dynamic gamma correction improves the gray levels frame by frame to enhance the dynamic images more clear to human eyes.

Current dynamic gamma correction is typically implemented with digital solutions, by which the image data of each frame are stored in image buffer or memory first, and then sent to the display device after a gamma correction algorithm that counts the gray levels of each frame to figure out the probability distribution of gray levels in the current frame as a histogram as shown in FIG. 1, and after a gamma correction calculation, modifies the probability distribution of gray levels in the current frame, for example by redistributing one or more gray levels toward higher or lower gray levels, to improve the image quality. Based on the probability distribution of gray levels shown in FIG. 1 for example, the gray levels of the processed frame are more concentrated in O-32 gray levels, and to have more clearly image pixels, some pixels in O-32 gray levels are moved to higher gray levels by a gamma correction calculation, as shown in FIG. 2. Although this scheme realizes a real-time correction, it requires huge amount of image buffers to store the display data before the histogram is extracted, and extremely high calculation speed to trace the frame timing. Therefore, the cost to implement this scheme is very high. Further, redistribution of the probability distribution of gray levels employed by this scheme will result in frame data distortions, i.e., changing the displayed image content.

Another scheme implements the dynamic gamma correction for a display system with analog solutions, and it counts the gray levels of each frame to figure out the probability distribution of gray levels in the current frame to obtain a histogram as shown in FIG. 1 first, and without changing the image data itself, adjusts the gamma voltages by the probability distribution of gray levels, i.e., the histogram of the processed frame. In this scheme, the more concentrated the gray levels are, the sharper the corrected gamma curve is. Based on the probability distribution of gray levels shown in FIG. 1 for example, FIG. 3 shows the gamma curve 10 before correction and a corrected gamma curve 12. Referring to FIG. 1, the gray levels of the processed frame are more concentrated in O-32 gray levels, and to have the gray levels in O-32 gray levels more different to each other to result in more clearly image, it increases the gamma voltage gradient of O-32 gray levels, and therefore the corrected curve 12 becomes more sharper in the segment of O-32 gray levels, as shown in FIG. 2. An implementation of such scheme is referred to Haeng Won Park, et al., “A Novel Method for Image Contrast Enhancement in TFT-LCDs: Dynamic Gamma Control (DGC)”, SID 03 Digest, pp. 1343-1345, 2003. Although this scheme obtains corrected gamma voltages without changing the image data, and achieve real-time correction at lower calculation speed than that of digital solutions, it still requires huge amount of image buffers to store the display data before the histogram is extracted.

Therefore, it is desired a simple and fast dynamic gamma correction using less buffers.

### SUMMARY OF THE INVENTION

One object of the present invention is to provide a dynamic gamma correction method and system in a frame-shifted manner.

Another object of the present invention is to provide a dynamic gamma correction method and system without requirement of much more image buffers.

In a dynamic gamma correction method and system, according to the present invention, the gray levels of a first frame are counted to obtain a probability distribution of gray levels simultaneously when the first frame is inputted to a source driver of an LCD, and a first plurality of gamma reference voltages generated according to the probability distribution of gray levels are supplied to the source driver for the gamma correction for a second frame when the second frame is inputted to the source driver. In the same way, when the second frame is inputted to the source driver, the gray levels of the second frame are counted to obtain a probability distribution of gray levels and to accordingly generate a second plurality of gamma reference voltages for the gamma correction for the third frame, and so on. Since the gamma reference voltages for the gamma correction for each frame are generated according to the probability distribution of gray levels in the previous frame, it requires small amount of image buffers for the processing, and it is also a real-time correction in a simple manner.

Since the frame-shifted dynamic gamma correction method and system use the gamma reference voltages of the previous frame for the gamma correction of the current frame, and the image data of the previous frame has been completely processed to generate the gamma reference voltages for the gamma correction of the current frame when the current frame is inputted to the source driver, it could perform the gamma correction for the current frame synchronously, and requires no more image buffers to store the image data of the current frame in advance before it is inputted to the source driver. The adjacent frames typically have very similar probability distribution of gamma voltages, and the human eyes are not so sensitive to the minor difference between two sequential frames, and therefore it will not influence the image quality when using the gamma reference voltages of the previous frame for the gamma correction of the current frame. Furthermore, the current frame is corrected with the gamma reference voltages generated from the previous frame, and therefore, when the current frame is inputted to the source driver, the image data of the previous frame has been completely processed to generate the gamma reference voltages for the current frame, resulting in real-time gamma correction.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a histogram representative of the probability distribution of gray levels of the pixels in a frame;

FIG. 2 shows a modified probability distribution of gray levels from that shown in FIG. 1;

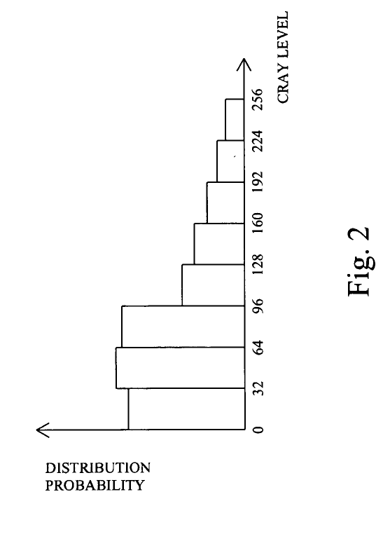

FIG. 3 shows the gamma curve 10 before correction and a corrected gamma curve 12 based on the probability distribution of gray levels shown in FIG. 1;

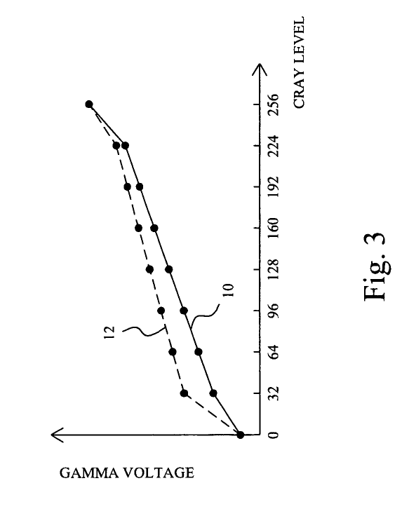

FIG. 4 shows a plurality of frames inputted sequentially to an LCD for image display; and

FIG. 5 shows a functional block diagram of an embodiment according to the present invention.

### DETAILED DESCRIPTION OF THE INVENTION

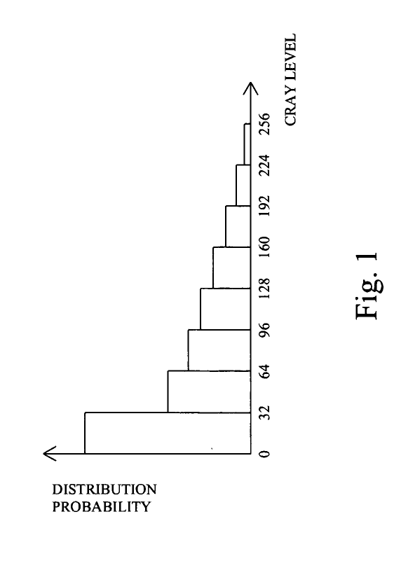

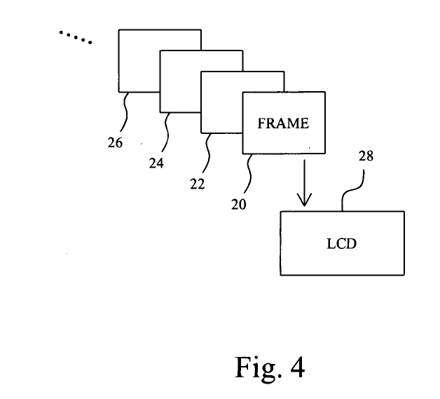

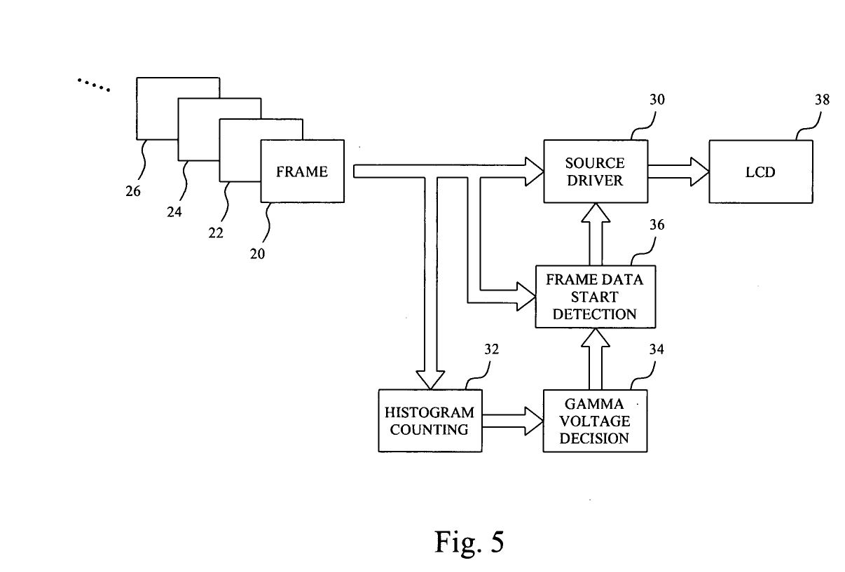

Before to illustrate the method and system of the present invention, the principle of an LCD system to display an image is briefly described in advance. FIG. 4 shows a plurality of frames inputted sequentially to an LCD for image display. A plurality of frames, for example frames 20, 22, 24 and 26, are provided one by one for the LCD 28 at a constant timing, i.e., frame timing, and therefore static or moving pictures are presented on the LCD 28 by the response of human eyes. Briefly, the principle of the present invention employs a retarded dynamic gamma correction. In particular, each frame is processed to provide the data for the gamma correction of the next frame. FIG. 5 shows a functional block diagram of an embodiment according to the present invention, in which the frames 20, 22, 24 and 26 for display are provided for an LCD 38 through a source driver 30, as a typical LCD system. When inputted to the source driver 30, however, each frame is also provided for a histogram counting 32 to figure out the probability distribution of gray levels of the pixels in the current frame, thereby generating a histogram such as that shown in FIG. 1, and conventional arts and their improvements may be applied for the histogram counting 32. A gamma voltage decision 34 is performed according to the statistic data from the histogram counting 32, and a plurality of gamma reference voltages are generated. Again, conventional arts and their improvements may be applied to perform the gamma voltage decision 34. In addition, a frame data start detection 36 is employed for synchronization to the frame timing, by which the gamma reference voltages are provided to the source driver 30 for the next frame when it is inputted to the source driver 30, and therefore, the source driver 30 could drive the LCD 38 with the corrected gamma voltages. The known synchronization techniques in image processing systems or video systems may be applied to detect the head of each frame for the frame data start detection 36. In this manner, the gamma reference voltages generated from the frame 20 are provided for the gamma correction of the frame 22, the gamma reference voltages generated from the frame 22 are provided for the gamma correction of the frame 24, the gamma reference voltages generated from the frame 24 are provided for the gamma correction of the frame 26, and so on. In other words, the gamma correction is performed in a retarded manner.

In the method and system, the current frame is corrected with the gamma reference voltages generated from the previous frame, and is used to generate the gamma reference voltages for the next frame. When the current frame is inputted to the source driver 30, the image data of the previous frame has been completely processed, and the gamma reference voltages for the current frame have been generated from the previous frame already, and therefore, it requires no more image buffers to store the image data of the current frame itself in advance for calculation of the probability distribution of gray levels to generate the gamma reference voltages for gamma correction before it is inputted to the source driver 30, and the memory capacity for the system is dramatically reduced accordingly. It is shown no requirements of huge image buffers and high calculation speed to store and process two or more frames simultaneously. Furthermore, the adjacent frames typically have very similar probability distribution of gamma voltages, and the human eyes are not so sensitive to the minor difference between two sequential frames, and therefore it will not influence the image quality when using the gamma reference voltages of the previous frame for the gamma correction of the current frame. In addition, the current frame is corrected with the gamma reference voltages generated from the previous frame, and therefore, when the current frame is inputted to the source driver 30, the image data of the previous frame has been completely processed to generate the gamma reference voltages for the current frame, resulting in real-time gamma correction.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A dynamic gamma correction method for a liquid crystal display to display an image including a plurality of frames, the method comprising the steps of:
counting gray levels in a first one of the plurality of frames for generating a statistic data;
determining gamma reference voltages according to the statistic data; and
performing a gamma correction for a second one of the plurality of frames with the gamma reference voltages.

2. The method of claim 1, further comprising providing the gamma reference voltages synchronous to the second one of the plurality of frames.

3. A dynamic gamma correction system for a liquid crystal display to display an image including a plurality of frames, the system comprising:
means for counting gray levels in a first one of the plurality of frames to generate a statistic data; and
means for determining gamma reference voltages according to the statistic data for a gamma correction of a second one of the plurality of frames.

4. The system of claim 3, further comprising means for providing the gamma reference voltages synchronous to the second one of the plurality of frames.
